(19) United States
(12) Patent Application Publication
(10) Pub. No.: US 2019/0103758 A1
(43) Pub. Date: Apr. 4, 2019

(54) VEHICLE-MOUNTED BACKUP DEVICE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Kazushi FUKAE, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/086,872

(22) PCT Filed: Aug. 25, 2017
(86) PCT No.: PCT/JP2017/030505

§ 371 Date: Sep. 20, 2018

(30) Foreign Application Priority Data
Sep. 6, 2016 (JP) 2016-173511

(51) Int. Cl. H02J 9/06; H02J 7/34; B60R 16/033

(52) U.S. Cl. CPC H02J 9/061; B60R 16/033; H02J 7/34

(57) ABSTRACT

A device is realized, with a simpler configuration, that is capable of switching a supply source to a power storage device without interrupting power supply to a recipient of power even if the power supply from a main power source is shut off. Provided is a wiring section to which a voltage is applied based on the output from the main power source in a normal condition; a wiring section provided between a power storage device and the wiring section; and a diode provided between the two wiring sections. The diode restricts the flow of current between the wiring sections when the voltage of the battery wiring section is smaller than the voltage of the main wiring section and allows the flow of current from the battery wiring section to the main wiring section when the voltage of the battery wiring section is greater.

### TECHNICAL FIELD

The disclosure relates to a vehicle-mounted backup device to backup a vehicle-mounted power source unit.

### BACKGROUND ART

A technology is known that, as a vehicle-mounted power source system, applies to a load a voltage that is adjusted by a step-up and step-down circuit based on the output voltage of a capacitor or a power storage unit when a failure or the like has occurred in a battery or a power supply unit. As this system applies to the load a voltage adjusted by the step-up and step-down circuit based on the output voltage of the capacitor after detecting that the battery has failed, there is the danger of a short interruption of the voltage applied to the load. In order to solve this problem, Patent Document 1 provides a smoothing capacitor in a step-up circuit. Accordingly, in. Patent Document 1, after the battery has failed, the output voltage stored in the smoothing capacitor can be applied to a load until the output voltage of a capacitor is applied to the load by adjusting it with the step-up circuit.

### CITATION LIST

### Patent Documents

Patent Document 1: JP 5618024

### SUMMARY

### Technical Problem

However, if the power consumption by the load that is the recipient of the power supply, is large, the system disclosed in Patent Document 1 requires that a smoothing capacitor with a larger capacity he provided therein, so that a plurality of smoothing capacitors or a larger smoothing capacitor needs to be provided. Accordingly, in the system disclosed in Patent Document 1, if the power consumption of the load is large, the circuitry tends to become larger, and the larger the power consumption is, the more significant this problem becomes.

The aspects of the following embodiments were made in view of the foregoing circumstances, and its object is to realize, with a simpler configuration, a device that can switch a supply source to a power storage unit without interrupting the power supply to a recipient of power even if the power supply from a power source unit is shut off.

### Solution to Problem

One aspect of a preferred embodiment relates to:

a backup device for a vehicle-mounted power source system that includes a power source unit for supplying power to a recipient of power and a power storage unit that serves as a power supply source at least when the power supply from the power source unit is shut off, the backup device comprising:

a first conducting path that is provided between the power source unit and the recipient of power and to which a voltage based on the output voltage of the power source unit is applied when the power supply from the power source unit is in a normal condition;

a second conducting path provided between the power storage unit and the first conducting path; and

an element member provided between the first conducting path and the second conducting path for restricting the flow of a current from the second conducting path to the first conducting path when the voltage of the second conducting path is smaller than the voltage of the first conducting path and for allowing the flow of a current from the second conducting path to the first conducting path when the voltage of the second conducting path is greater than the voltage of the first conducting path.

### Advantageous Effects of Preferred Embodiments

This backup device can supply power to the recipient of power, using the power source unit as the supply source and the first conducting path as the route, when the power source unit is in a normal condition. In addition, as a power storage unit is provided that can supply power to the first conducting path via the element member, if no power is supplied from the power source unit to the first conducting path due to a failure or the like of the power source unit, backup can be performed to supply power to the recipient of power from the power storage unit. Additionally, the element member restricts the flow of current from the second conducting path to the first conducting path when the voltage of the second conducting path is smaller than the voltage of the first conducting path, and allows the flow of current from the second conducting path to the first conducting path when the voltage of the second conducting path is greater than the voltage of the first conducting path. As the element member is configured in this manner, when the voltage of the first conducting path is greater than the second conducting path due to the power supply from the power source unit (when the voltage of the second conducting path is smaller than the voltage of the first conducting path), current can be prevented from flowing into the first conducting path from the power storage unit via the second conducting path.

Accordingly, when the power supply from the power source unit is in a normal condition, discharge of the power storage unit can be suppressed. On the other hand, if the voltage of the first conducting path is reduced due to a failure or the like of the power source unit so that the voltage of the second conducting path is greater than the voltage of the first conducting path, a discharge current from the power storage unit is immediately allowed to flow into the first conducting path via the second conducting path.

In this way, even if power supply from the power source unit is shut off, the supply source can be switched to the power storage unit without interruption of power supply to the recipient of power.

### BRIEF DESCRIPTION OF DRAWINGS

FIG. 1 is a circuit diagram schematically showing a vehicle-mounted power source system that includes a backup device of Embodiment 1.

FIG. 2 is a circuit diagram schematically showing a vehicle-mounted power source system that includes a backup device of Embodiment 2.

FIG. 3 is a circuit diagram schematically showing a vehicle-mounted power source system that includes a backup device of Embodiment 3.

FIG. 4 is a circuit diagram schematically showing a vehicle mounted power source system that includes a backup device of Embodiment 4.

### DESCRIPTION OF EMBODIMENTS

Preferred examples will be described hereinafter. The present disclosure, however, is not limited to the following examples.

A backup device of an aspect of a preferred embodiment can comprise: a discharge circuit arranged in parallel with a second conducting path between a power storage unit and a first conducting path for performing a discharge operation to output a target voltage set for the first conducting path based on the output voltage from the power storage unit and a stop operation to stop the discharge operation; and a control unit for controlling the discharge circuit. The control unit can function to cause the discharge circuit to perform a discharge operation at least when the power supply from the power source unit to the first conducting path is stopped.

The backup device thus configured can apply the set target voltage to the first conducting path by the discharge operation of the discharge circuit. If it takes time for the discharge circuit to apply the target voltage to the first conducting path after a failure or the like occurs in the power source unit, power interruption can be more reliably prevented as power is instantaneously supplied via the second conducting path immediately after the failure, etc.

In the backup device of a preferred embodiment, the output voltage of the power storage unit when it is fully charged may be smaller than the voltage applied to the first conducting path based on the output voltage of the power source unit when the power source unit is fully charged. The element member may be a diode that has an anode electrically connected to the power storage unit via the second conducting path and a cathode electrically connected to the first conducting path.

In the backup device thus configured, as the voltage of the second conducting path disposed on the anode side of the diode is smaller than the voltage of the first conducting path disposed on the cathode side when the power supply from the power source unit is in a normal condition, the flow of current from the second conducting path to the first conducting path can be restricted. In addition, as the voltage of the second conducting path disposed on the anode side of the diode is greater than the voltage of the first conducting path disposed on the cathode side when the power supply from the power source unit is shut off, it is possible to immediately pass a current from the second conducting path to the first conducting path. Moreover, such functions can be easily implemented with the diode as the principal.

The output voltage of the power storage unit, when it is fully charged, may be greater than the voltage applied to the first conducting path based on the output voltage of the power source unit when the power source unit is fully charged. A Zener diode having a cathode electrically connected on the power storage unit side and an anode electrically connected on the element member side may be provided between the power storage unit and the second conducting path. The element member may be a diode that has an anode electrically connected to the second conducting path and a cathode electrically connected to the first conducting path.

The backup device thus configured can reduce the voltage applied to the second conducting path (the voltage applied via the Zener diode based on the power supply from the power storage unit) due to the presence of the Zener diode. If the relationship between the voltage of the second conducting path thus reduced and the voltage applied to the first conducting path when the power supply from the power source unit is in a normal condition is such that the voltage of the second conducting path is lower than the voltage applied to the first conducting path, low from the second conducting path side to first conducting path side can be prevented to prevent discharge of the power storage unit in a normal condition. In this way, the configuration is such that discharge of the power storage unit can be easily prevented even if the voltage of the power storage unit is high when it is fully charged.

The output voltage of the power storage unit when it is fully charged may be greater than the voltage applied to the first conducting path based on the output voltage of the power source unit when the power source unit is fully charged. A Zener diode provided between the power storage unit and the second conducting path and having a cathode electrically connected on the power storage unit side and an anode electrically connected on the element member side, and a switching element; provided between the power storage unit and the second conducting path and being turned ON when the Zener diode breaks down to establish conduction between the power storage unit and the second conducting path may be included. The element member may be a diode that has an anode electrically connected to the second conducting path and a cathode electrically connected to the first conducting path.

The backup device thus configured can reduce the voltage applied to the second conducting path (the voltage applied via the Zener diode based on the power supply from the power storage unit) due to the presence of the Zener diode. If the relationship between the voltage of the second conducting path thus reduced and the voltage applied to the first conducting path when the power supply from the power source unit is in a normal condition is such that the voltage of the second conducting path is lower than the voltage applied to the first conducting path, flow from the second conducting path side to first conducting path side can be prevented to prevent discharge of the power storage unit in a normal condition. On the other hand, if the voltage of the first conducting path goes below the voltage of the second conducting path due to a failure or the like of the power source unit, the potential difference between the power storage unit side and the second conducting path becomes larger so that a current flows to the first conducting path side from the power storage unit due to breakdown of the Zener diode. In addition, as the switching element is turned ON in response to the breakdown of the Zener diode, the current that flows not via the Zener diode (the current that flows via the switching element) can be made larger. This can restrain the development of heat in the Zener diode due to a large current flowing through the Zener diode.

The following describes Embodiments 1-4 that embody aspects of various preferred embodiments.

### Embodiment 1

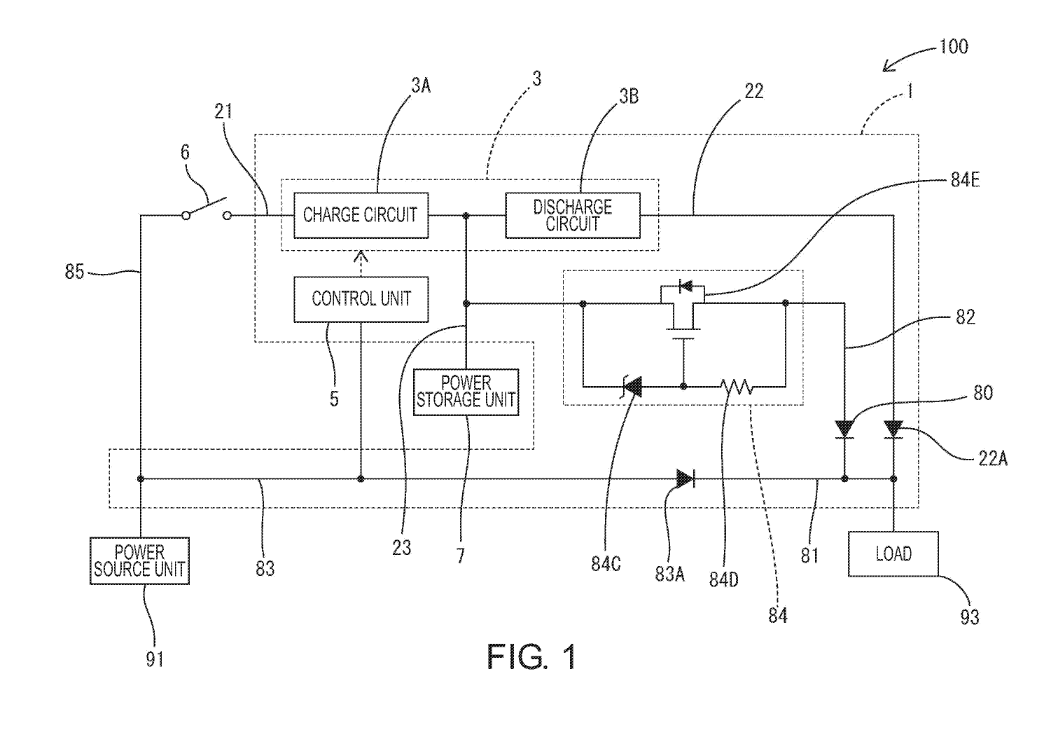

FIG. 1 is a block diagram showing a vehicle-mounted power source system 100 that includes a vehicle-mounted backup device 1 according to Embodiment 1. The vehicle-mounted power source system 100 includes a power source unit 91 (main power source) that is the main power source for supplying power to a load 93 (a recipient of power), a power storage unit 7 (power storage device) that serves as a power supply source at least when the power supply from the power source unit 91 is shut off, and a backup device 1 that promptly performs power discharge from the power storage unit 7 when the power supply from the power source unit 91 is shut off. The system is configured to supply power to the load 93, using the power source unit 91 or the power storage unit as the power supply source.

When the power supply from the power source unit 91 is in a normal condition, the vehicle-mounted power source system 100 is configured to apply a voltage based on the output voltage of the power source unit 91 to a wiring section 81 (a first conducting path) and supply power to the load 93 (the recipient of power) from the power source unit 91 via the wiring section 81. In this configuration, “when the power supply from the power source unit 91 is normal” is when the output voltage of the power source unit 91 is above “a predetermined value,” specifically, when the voltage applied to the wiring section 81 (the first conducting path) based on the output voltage of the power source unit 91 (specifically, the voltage applied to the wiring section 81 based on the power supplied from the power source unit 91 via a wiring section 83 and a diode 83A) is greater than the voltage applied to a wiring section 82 based on the output voltage of the power storage unit 7.

The backup device 1 includes a discharge circuit 3B and is configured to switch between discharge and a discharge stop of the power storage unit 7 using the discharge circuit 3B and to allow for supplying power to the load 93 from the power storage unit 7 during discharge.

The power source unit 91 is configured as a known vehicle-mounted battery, for example, a lead battery, etc. The power source unit 91 has its terminal on the high potential side connected to a wiring section 85 and to the wiring section 83 to apply a predetermined output voltage (also referred to as a +B voltage) to the wiring section 85 and the wiring section 83.

The power storage unit 7 is comprised of a known storage means, for example, an electric double layer capacitor (EDLC), etc. The power storage unit 7 is electrically connected to a charge/discharge circuit section 3 to be charged and discharged by the charge/discharge circuit section 3. It should be noted that, in Embodiment 1, the voltage of the power storage unit 7 when it is fully charged is greater than the voltage of the power source unit 91 when it is fully charged.

The load 93 represents an example of the recipient of power and is configured as a known vehicle mounted electrical component. Suitable examples of the load 93 are electrical components, for example, an ECU or actuators, etc., in a shift-by-wire system that is properly supplied with power even if the power source unit 91 has failed. The load 93 operates based on the power supplied from the power source unit 91 in the above-described normal condition and operates based on the power supplied from the power storage unit 7 in an abnormal condition.

The IG relay 6 is a relay that switches to an ON condition when a predetermined start operation to start the engine (an ignition ON operation (IG ON operation)) is performed on an operation unit (not shown) provided in the vehicle and to an OFF condition when a predetermined stop operation to stop the engine (an ignition OFF operation (IG OFF operation)) is performed on the operation unit. The IG relay 6 assumes a conducting state in the ON condition to establish conduction between the wiring section 85 and a charge-circuit-side conducting path 21. Due to the ON operation of this IG relay 6, the power source voltage of the power source 91 (the +B voltage) is supplied to a charge-circuit-side conducting path 21. When. In the OFF condition, the IG relay 6 assumes a non-conducting state in which the power source voltage applied to the wiring section 85 (the +B voltage) is not supplied to the charge-circuit-side conducting path 21. It should be noted that, in the following description, the power source voltage (the +B voltage) applied to the charge-circuit-side conducting path 21 via the IG relay 6 is also referred to as the IG voltage.

The backup device 1 mainly includes the charge-circuit-side conducting path 21, a discharge-circuit-side conducting path 22, a storage-unit-side conducting path 23, the charge/discharge circuit section 3, the wiring section 81, the wiring section 83, an auxiliary circuit section 84, and a control unit 5, for example.

The charge-circuit-side conducting path 21 is a conducting path that becomes conductive to the wiring section 85 when the ignition relay 6 (also referred to as the IG relay 6 hereinafter) is turned ON (when in a conducting state), and it is a conducting path on the input side of a charge circuit 3A.

The discharge-circuit-side conducting path 22 is a conducting path that is the route for passing current from the discharge circuit 3B to the wiring section 81. In addition, a diode 22A is provided in the discharge-circuit-side conducting path 22. The anode of the diode 22A is electrically connected to the discharge circuit 3B via the discharge-circuit-side conducting path 22, and its cathode is electrically connected to the load 93 via the wiring section 81. As the diode 22A is provided in this way, no current flows to the discharge circuit 3B side from the wiring section 81 side, so that when the voltage of the discharge-circuit-side conducting path 22 is greater than the voltage of the wiring section 81 due to the discharge operation of the discharge circuit 3B, the output current from the discharge circuit 3B is caused to flow into the wiring section 81.

The storage-unit-side conducting path 23 is electrically connected to the power storage unit 7, and it is also the charge route from the charge circuit 3A to the power storage unit 7 and the discharge route from the power storage unit 7 to the discharge circuit 3B.

The charge/discharge circuit section 3 includes the charge circuit 3A and the discharge circuit 3B and is capable of performing a charge operation to charge the power storage unit 7 based on the power from the power source unit 91 and a discharge operation to discharge the power storage unit 7. The charge operation of the charge circuit 3A is controlled by the control unit 5, and the discharge operation of the discharge circuit 3B is also controlled by the control unit 5.

A charge instruction signal to instruct the power storage unit 7 to charge and a charge stop signal to instruct the power storage unit 7 to stop charging are provided to the charge circuit 3A by the control unit 5. The charge circuit 3A is configured as a known charge circuit, for example, a step-up DCDC converter, or the like, so as to perform a voltage transforming operation to increase the source voltage inputted by the power source unit 91 via the charge-circuit-side conducting path 21 while a charge instruction signal is given to the charge circuit 3A from the control unit 5 and to apply that stepped-up voltage to the power storage unit 7 via the storage-unit-side conducting path 23. While a charge stop signal is given to the charge circuit 3A from the control unit 5, the charge circuit 3A does not perform a charge operation; during this period, the charge-circuit-side conducting path 21 is brought into a non-conducting state with the storage-unit-side conducting path 23.

The discharge circuit 3B is arranged in parallel with the wiring section 82 (the second conducting path) between the power storage unit 7 and the wiring section 81 (the first conducting path) (specifically between the storage-unit-side conducting path 23 and the wiring section 81) and is capable of performing a discharge operation to discharge the power storage unit 7 and a discharge stop operation to stop charging of the power storage unit 7. The discharge circuit 3B is configured as a known discharge circuit, for example, a step-up and step-down DCDC converter, etc. This discharge circuit 3B performs: a discharge operation to output a target voltage set for the wiring section 81 (the first conducting path) based on the input voltage applied to the storage-unit-side conducting path 23 (the output voltage from the power storage unit 7) (in particular, a discharge operation to apply the target voltage to the discharge-circuit-side conducting path 22 as instructed by the control unit 5) when a discharge instruction signal is given by the control unit 5; and stops this discharge operation to bring the storage-unit-side conducting path 23 into a non-conducting state with the discharge-circuit-side conducting path 22 when a charge stop signal is given by the control unit 5.

The wiring section 83 is provided between the power source unit 91 and the wiring section 81 and configured as a route to which the output voltage of the power source unit 91 is applied. The diode 83A is provided in the wiring section 83 with the anode of the diode 83A electrically connected to the power source unit 91 via the wiring section 83 and the cathode electrically connected to the wiring section 81. This diode 83A allows a current to flow to the wiring section 81 side from the power source unit 91 and blocks the flow of current to the power source unit 91 side from the wiring section 81. For example, if an abnormality, such as a ground fault, occurs, no current is allowed to flow into the wiring section 83 side from the wiring section 81.

An auxiliary circuit section 84 is provided between the storage-unit-side conducting path 23 and the wiring section 81 and configured as the route to supply power from the power storage unit 7 when the power supply from the power source unit 91 to the wiring section 81 is shut off. The auxiliary circuit section 84 includes the wiring section 82, a diode 80, a Zener diode 84C, a switching element 84E, and a resistor unit 84D, and is arranged in parallel with the discharge circuit 3B.

The wiring section 82 represents an example of the second conducting path that is provided between the power storage unit 7 and the wiring section 81 (the first conducting path), and it is a conducting path to which a voltage corresponding to the output voltage of the power storage unit 7 can be applied.

The diode 80 represents an example of an element member and is provided between the wiring section 81 (the first conducting path) and the wiring section 82 (the second conducting path) with its anode electrically connected to the wiring section 82 and its cathode electrically connected to the wiring section 81. This diode 80 does not pass a current from the wiring section 81 side to the wiring section 82 side and, when the voltage of the wiring section 82 is greater than the voltage of the wiring section 81, allows a current to flow from the wiring section 82 to the wiring section 81. Moreover, when the voltage of the wiring section 82 is smaller than the voltage of the wiring section 81, the flow of current is restricted from the wiring section 82 to the wiring section 81 to block the flow of current from the wiring section 82 to the wiring section 81.

The auxiliary circuit section 84 is provided between the diode 80 and the storage-unit-side conducting path 23. The auxiliary circuit section 84 includes the Zener diode 84C, the resistor unit 84D, and the switching element 84E. The cathode of the Zener diode 84C is electrically connected to the storage-unit-side conducting path 23 with its anode electrically connected to one end of the resistor unit 84D and to the gate of the switching element 84E. The other end of the resistor unit 84D, opposite to the Zener diode 84C side, is electrically connected to the wiring section 82. That is to say, the Zener diode 84C and the resistor unit 84D are connected in series between the storage-unit-side conducting path 23 and the wiring section 82.

The switching element 84E is configured as an N-channel MOSFET with its drain electrically connected to the storage-unit-side conducting path 23 and also to the cathode of the Zener diode 84C and the power storage unit 7 via the storage-unit-side conducting path 23. The source of the switching element 84E is electrically connected to the wiring section 82 and also electrically connected to the anode of the diode 80 via the wiring section 82. As the gate of the switching element 84E is electrically connected to the anode of the Zener diode 84C and one end of the resistor unit 84D, if the Zener diode 84C breaks down to cause a current to flow through the Zener diode 84C and the resistor unit 84D, it is turned ON to become conductive when the gate-source voltage VGS exceeds a predetermined threshold value.

The control unit 5 is configured, for example, as a microcomputer and includes an arithmetical unit, such as a CPU, a memory, such as a ROM or RAM, and an A/D converter, etc. The voltage of the wiring section 83 (that is, the output voltage value of the power source unit 91) is inputted to the control unit 5, and the control unit 5 is configured to continuously monitor the voltage of the wiring section 83. It should be noted that the configuration shown in FIG. 1 is merely an example and that any configuration will suffice as long as the control unit 5 can detect the output voltage of the power source unit 91; it may monitor the voltage at any other location as long as it is on a route electrically connected to the power source unit 91. Furthermore, the configuration to input to the control unit 5 a value indicating the voltage of a route electrically connected to the power source unit 91 may be, as shown in FIG. 1, a configuration whereby the voltage of the route is directly inputted to the control unit 5, or the voltage of the route may be divided by a voltage dividing circuit, etc., so as to be inputted to the control unit 5.

The control unit 5 can control the charge operation and the discharge operation of the charge/discharge circuit section 3. Specifically, the control unit 5 can provide a charge instruction signal or a charge stop signal to the charge circuit 3A and provide a discharge instruction signal or a discharge stop signal to the discharge circuit 3B.

The following describes the operation of the backup device 1.

When an IC ON operation (an ON operation to turn ON the ignition switch) is performed in the vehicle on which the vehicle-mounted power source system 100 is installed, the IG relay 6 is switched over to an ON state from an OFF state to establish conduction between the wiring section 85 and the charge-circuit-side conducting path 21. This causes the IG voltage to he applied to the backup device 1.

The control unit 5 monitors the output voltage of the power source unit 91 at least from when the ignition switch is turned ON until it is turned OFF. In the backup device 1, a predetermined threshold value Vth is set as a value that is greater than the voltage V2 of the power storage unit 7 when it is fully charged minus the breakdown voltage VZ of the Zeiler diode 84C (V2-VZ) and is smaller than the voltage of the power source unit 91 when it is fully charged, and the control unit 5 continuously monitors whether or not the voltage of the wiring section 83 (i.e., the output voltage of the power source unit 91) is greater than the threshold value Vth. It should be noted that the voltage of the wiring section. 83 (the output voltage of the power source unit 91) is greater than the threshold value Vth when the power is properly supplied to the wiring section 81 from the power source unit 91 and when the flow of current is blocked, from the wiring section 82 to the wiring section 81.

The charge operation of the charge circuit 3A is performed at a predetermined charge start timing (e.g., immediately after the ignition switch is turned ON) when the voltage of the wiring section 83 (i.e., the output voltage of the power source unit 91) is greater than the threshold value Vth, and a charge instruction signal is given to the charge circuit 3A from the control unit 5 until the output voltage of the power storage unit 7 (the charge voltage) reaches the target voltage. This “predetermined target voltage” represents an example of “the output voltage” of the power storage unit 7 “when it is fully charged” and is denoted as V2 in this description. In this configuration, from when the output voltage of the power storage unit 7 (the charge voltage) has reached a predetermined target voltage following the start of a charge operation at the predetermined charge start timing up to a predetermined discharge start timing (when a discharge operation of the discharge circuit 3B starts or up to when a discharge current starts to flow through the wiring section 81 via the wiring section 82), the output voltage of the power storage unit 7 (the charge voltage) is maintained at the predetermined target voltage (the output voltage when fully charged). In addition, this predetermined target voltage (the output voltage of the power storage unit 7 when it is fully charged) is greater than the voltage applied to the wiring section 81 (the first conducting path) based on the output voltage of the power source unit 91 when the power source unit 91 is fully charged.

The situation in which the power supply from the power source unit 91 is in a normal condition will be now described.

When the ignition switch is in ON condition (when the IG relay 6 is in ON condition), the power supply from the power source unit 91 can be judged to be normal if the voltage of the wiring section 83 (the output voltage of the power source unit 91) is greater than the threshold value Vth. If the voltage of the wiring section 83 (the output voltage of the power source unit 91) is greater than the threshold value Vth when the IG relay 6 is in ON condition, the control unit 5 maintains the discharge circuit 3B in a discharge stop state and blocks conduction between the storage-unit-side conducting path 23 and the discharge-circuit-side conducting path 22.

Additionally, if the voltage of the wiring section 83 (the output voltage of the power source unit 91) is greater than the threshold value Vth when the IG relay 6 is in ON condition, the flow of current from the wiring section 81 to the wiring section 82 is also blocked. In this configuration, the Zener diode 84C and the resistor unit 84D are provided in series between the power storage unit 7 and the wiring section 82 (the second conducting path) with the cathode of the Zener diode 84C electrically connected on the power storage unit 7 side and its anode electrically connected on the diode 80 side. Moreover, as the threshold value Vth is greater than the voltage V2 of the power storage unit 7 when it is fully charged minus the breakdown voltage VZ of the Zener diode 84C (V2-VZ), if at least the voltage of the wiring section 83 (the output voltage of the power source unit 91) is greater than the threshold value Vth, the potential difference between the storage-unit-side conducting path 23 and the wiring section 82 does not exceed the breakdown voltage VZ of the Zener diode 84C, so that no current flows through the Zener diode 84C or the resistor unit 84D. As the switching element 84E is not turned ON if no current flows through the Zener diode 84C and the resistor unit 84D, the non-conducting state is maintained between the storage-unit-side conducting path 23 and the wiring section 82.

In this way, while the power supply from the power source unit 91 is normal when the IG relay 6 is in ON condition, no power can be supplied by the power storage unit 7 either via the route of the discharge circuit 3B or via the route of the wiring section 82, the power storage unit 7 is maintained in a discharge stop state, so that the load 93 is operated only by power from the power source unit 91.

Then, if an IG OFF operation (operation to turn OFF the ignition switch) is performed in such a normal condition, the IG relay 6 is switched from an ON state to an OFF state to block conduction between the wiring section 85 and the charge-circuit-side conducting path 21. It should be noted that, after the IG relay 6 is switched from an ON state to an OFF state, the discharge circuit 3B may be operated to perform discharge so as to maintain the output voltage of the power storage unit 7 (the discharge voltage) to a value below the voltage V2 when the IG relay 6 is in the ON state.

The following describes the operation when a normal condition changes to an abnormal condition when the ignition switch is in ON condition.

If an abnormality occurs in the power supply from the power source unit 91 (e.g., occurrence of a ground fault or breakage in the vicinity of the power source unit 91) when the ignition switch is in ON condition (i.e., when the IG relay 6 is in ON condition) to shuts off the power supply from the power source unit 91 to the wiring section 81, the value of the voltage applied to the wiring section 83 (the +B voltage) changes from greater than the threshold value Vth to equal to or less than threshold value Vth. If the power supply from the power source unit 91 to the wiring section 81 (the first conducting path) is stopped (specifically, if the voltage of the wiring 83 becomes less than threshold value Vth) as above, the control unit 5 switches the signal given to the discharge circuit 3B from a discharge stop signal to a discharge instruction signal to cause the discharge circuit 3B to perform a discharge operation to apply the predetermined target voltage (e.g., a voltage equivalent to the output voltage of the power source unit 91 when it is fully charged) to the discharge-circuit-side conducting path 22.

In this configuration, the discharge circuit 3B is configured as a step-up and step-down DCDC converter whose input voltage is the voltage applied to the storage-unit-side conducting path 23 and that inputs a desired voltage to the discharge-circuit-side conducting path 22, wherein if the output voltage of the power storage unit 7 applied to the storage-unit-side conducting path 23 (the charge voltage) is lower than the predetermined target voltage, the control unit 5 causes the discharge circuit 3B to perform a step-up operation so that the discharge circuit 3B applies the predetermined target voltage to the discharge-circuit-side conducting path 22. Additionally, if the output voltage of the power storage unit 7 applied to the storage-unit-side conducting path 23 (the charge voltage) is higher than the predetermined target voltage, the control unit 5 causes the discharge circuit 3B to perform a step-down operation so that the discharge circuit 3B applies the predetermined target voltage to the discharge-circuit-side conducting path 22. It should he noted that the control unit 5 additionally has the capability to detect the voltage of the storage-unit-side conducting path 23 (the output voltage of the power storage unit 7).

Additionally, in this configuration, the control unit 5 detects that the voltage of the wiring section 83 becomes less than the threshold value Vth, and then the discharge circuit 3B performs a discharge operation after the control unit 5 starts a discharge instruction signal, so that it takes time for the target voltage to be applied by the discharge circuit 3B after the point of time at which the abnormality of power supply occurs. Accordingly, this configuration overcomes this problem by employing an arrangement to allow for immediate power supply via the wiring section 82 in the event of abnormality.

In this configuration, if the voltage of the wiring section 81 is greatly reduced compared to when in a normal condition due to the shutoff of the power supply from the power source unit 91, the voltage of the wiring section 82 connected to the anode side of the diode 80 is greater than the voltage of the wiring section 81 connected to the cathode side, so that a current immediately flows from the wiring section 82 to the wiring section 81. In this way, as a current can be immediately passed through the wiring section 81, the power supply to the load 93 is maintained until a discharge operation of the discharge circuit 3B is started.

Furthermore, in this way, if the voltage of the wiring section 81 is greatly reduced compared to when in a normal condition, the potential difference between the storage-unit-side conducting path 23 and the wiring section 82 becomes larger so that the potential difference between both ends of the Zener diode 84C becomes larger than the Zener voltage, so that a current flows through the Zener diode 84C and the resistor unit 84D due to breakdown of the Zener diode 84C. Then, as the switching element 84E is turned ON due to the potential difference between the gate and the source of the switching element 84E becoming larger, a current flows through the switching element 84E to restrain the current through the Zener diode 84C. In this way, the switching element 84E is turned ON when the Zener diode 84C breaks down to establish conduction between the power storage unit 7 and the wiring section 85 to restrain the current through the Zener diode 84C.

In this way, the backup device 1 of this configuration can supply power to the load 93 (the recipient of power), using the power source unit 91 as the supply source and the wiring section 81 (the first conducting path) as the route when the power source unit 91 is in a normal condition. In addition, as the power storage unit 7 is provided that can supply power to the wiring section 81 (the first conducting path) via the diode 80 (the element member), if no power is supplied from the power source unit 91 to the wiring section 81 (the first conducting path) due to a failure or the like of the power source unit 91, backup can be performed to supply power to the recipient of power from the power storage unit 7. Additionally, the diode 80 (the element member) restricts the flow of current from the wiring section 82 to the wiring section 81 when the voltage of the wiring section 82 is smaller than the voltage of the wiring section 81, and allows the flow of current from the wiring section 82 to the wiring section 81 when the voltage of the wiring section 82 is greater than the voltage of the wiring section 81. As the diode 80 (the element member) is configured in this manner, when the voltage of the wiring section 81 is greater than the wiring section 82 due to the power supply from the power source unit 91 (when the voltage of the wiring section 82 is smaller than the voltage of the wiring section 81), current can be prevented from flowing into the wiring section 81 from the power storage unit 7 via the wiring section 82. Accordingly, when the power supply from the power source unit 91 is in a normal condition, discharge of the power storage unit 7 can be suppressed. On the other hand, if the voltage of the wiring section 81 is reduced due to a failure or the like of the power source unit 91 so that the voltage of the wiring section 82 is greater than the voltage of the wiring section 81, a discharge current from the power storage unit 7 can be immediately allowed to flow into the wiring section 81 via the wiring section 82.

In this way, even if power supply from the power source unit 91 is shut off, the supply source can be switched to the power storage unit 7 without interruption of power supply to the load 93 (the recipient of power).

The backup device 1 of this configuration includes the discharge circuit 3B and the control unit 5 that controls the discharge circuit 3B. The discharge circuit 3B is arranged in parallel with the wiring section 82 between the power storage unit 7 and the wiring section 81 and performs a discharge operation to output the target voltage set for the wiring section 81 based on the output voltage from the power storage unit 7 and a stop operation to stop the discharge operation. The control unit 5 functions to cause the discharge circuit 3B to perform a discharge operation at least when the power supply from the power source unit 91 to the wiring section 81 is stopped.

The backup device 1 thus configured can apply the set target voltage to the wiring section 1 by a discharge operation of the discharge circuit 3B. If it takes time for the discharge circuit 3B to apply the target voltage to the wiring section 81 after a failure or the like occurs in the power source unit 91, power interruption can be more reliably prevented as power is instantaneously supplied via the wiring section 82 immediately after the failure, etc.

In the backup device 1 of this configuration, the output voltage V2 of the power storage unit 7 when it is fully charged is greater than the voltage applied to the wiring section 81 based on the output voltage of the power source unit 91 when the power source unit 91 is fully charged. In addition, the backup device 1 includes the Zener diode 84C, which is provided between the power storage unit 7 and the wiring section 82 and has its cathode electrically connected on the power storage unit 7 side and its anode electrically connected on the diode 80 side, and the switching element 84E, which is provided between the power storage unit 7 and the wiring section 82 and is turned ON when the Zener diode 84C breaks down to establish conduction between storage unit 7 and the wiring section 82.

The backup device 1 thus configured can reduce the voltage applied to the wiring section 82 (the voltage applied via the Zener diode 84C based on the power supply from the power storage unit 7) due to the presence of the Zener diode 84C. If the relationship between the voltage of the wiring section 82 thus reduced and the voltage applied to the wiring section 81 when the power supply from the power source unit 91 is in a normal condition is such that the voltage of the wiring section 82 is lower than the voltage applied to the wiring section 81, flow from the wiring section 82 side to the wiring section 81 side can be prevented to prevent discharge of the power storage unit 7 in a normal condition. On the other hand, if the voltage of the wiring section 81 goes below the voltage of the wiring section 82 due to a failure or the like of the power source unit 91, the potential difference between the power storage unit 7 side and the wiring section 82 becomes larger so that a current flows to the wiring section 81 side from the power storage unit 7 due to breakdown of the Zener diode 84C. In addition, as the switching element 84E is turned ON in response to the breakdown of the Zener diode 84C, the current that flows not via the Zener diode 84C (the current that flows via the switching element 84E) can be made larger. This can restrain the development of heat in the Zener diode 84C due to a large current flowing through the Zener diode 84C.

### Embodiment 2

The following describes a second embodiment.

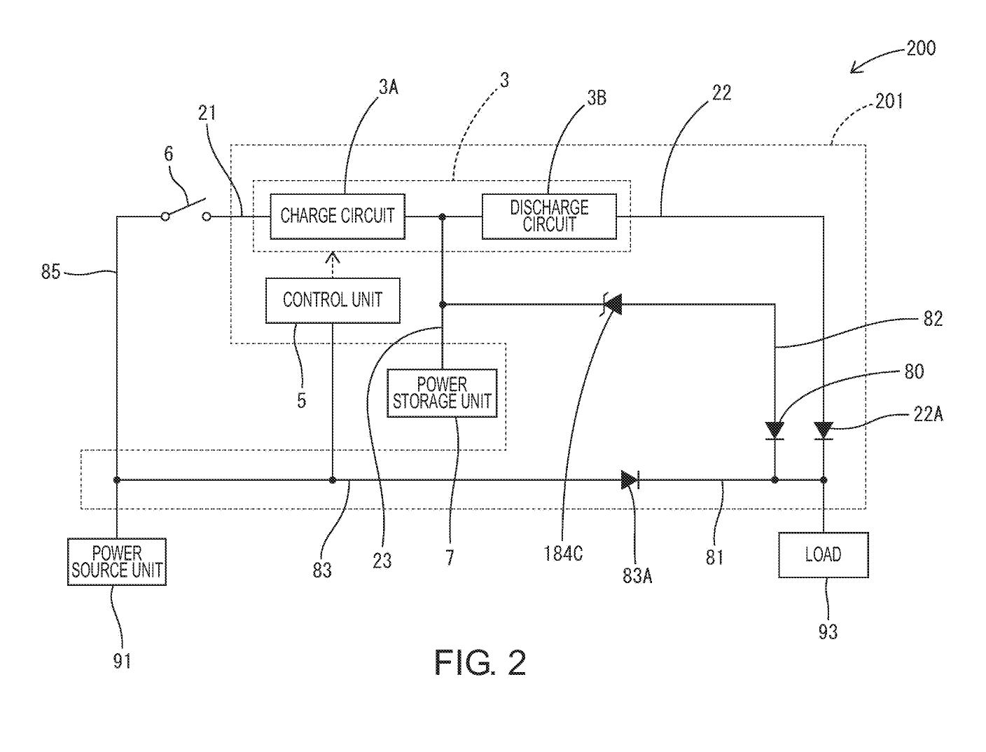

FIG. 2 shows a vehicle-mounted power source system 200 that employs a backup device 201 according to Embodiment 2. This vehicle-mounted power source system 200 and the backup device 201 differs from Embodiment 1 in that a Zener diode 184C is provided in place of the auxiliary circuit section 84, while the remaining circuit configuration is identical with Embodiment 1.

Additionally, the various controls can be performed by the control unit 5 in the same manner as in Embodiment 1. In the vehicle-mounted power source system 200 of Embodiment 2, the same components as in Embodiment 1 will be denoted with the same reference symbols, and their detailed description will be omitted.

Also in this configuration, the wiring section 81 (the first conducting path) is provided between the power source unit 91 and the load 93 (the recipient of power) and configured to have a voltage based on the output voltage of the power source unit 91 applied thereto when the power supply from the power source unit 91 is in a normal condition. Additionally, the wiring section 82 is provided between the power source unit 7 and the wiring section 81 and configured to have a voltage applied thereto corresponding to the output voltage of the power source unit 7. Also, the diode 80 functions as an example of the element member, is provided between the wiring section 81 and the wiring section 82, restricts the flow of current from the wiring section 82 to the wiring section 81 when the voltage of the wiring section 82 is smaller than the voltage of the wiring section 81, and allows the flow of current from the wiring section 82 to the wiring section 81 when the voltage of the wiring section 82 is greater than the voltage of the wiring section 81.

In this configuration, the Zeiler diode 184C is provided between the power storage unit 7 and the wiring section 82 (the second conducting path) with the Zener diode 184C having its cathode electrically connected on the power storage unit 7 side and its anode electrically connected on the diode 80 side. Specifically, the output voltage of the power storage unit 7 is applied to the cathode of the Zener diode 184C via the storage-unit-side conducting path 23, and the anode of the Zener diode 184C is electrically connected to the anode on the diode 80 side via the wiring section 82.

The following describes the operation of the backup device 201.

Also in this configuration, when an IG ON operation (an ON operation to turn ON the ignition switch) is performed in the vehicle on which the vehicle-mounted power source system 200 is installed, the IG relay 6 is switched over to an ON state from an OFF state to establish conduction between the wiring section 85 and the charge-circuit-side conducting path 21. This causes the IG voltage to be applied to the backup device 201.

Then, the control unit 5 monitors the output voltage of the power source unit 91 at least from when the ignition switch is turned ON until it is turned OFF. In the backup device 201, a predetermined threshold value Vth is set as a value that is greater than the voltage V2 of the power storage unit 7 when it is fully charged minus the breakdown voltage VZ of the Zener diode 184C (V2-VZ) and is smaller than the voltage of the power source unit 91 when it is fully charged, and the control unit 5 continuously monitors whether or not the voltage of the wiring section 83 the output voltage of the power source unit 91) is greater than the threshold value Vth. Also in this example, the voltage of the wiring section 83 (the output voltage of the power source unit 91) is greater than the threshold value Vth when the power is appropriately supplied to the wiring section 81 from the power source unit 91 and when the flow of current is blocked from the wiring section 82 to the wiring section 81.

Also in this configuration, the charge operation of the charge circuit 3A is performed at a predetermined charge start timing (e.g., immediately after the ignition switch is turned ON) when the voltage of the wiring section 83 (i.e., the output voltage of the power source unit 91) is greater than the threshold value Vth, and a charge instruction signal is given to the charge circuit 3A from the control unit 5 until the output voltage of the power storage unit 7 (the charge voltage) reaches the target voltage. This “predetermined target voltage” represents an example of “the output voltage” of the power storage unit 7 “when it is fully charged” and is denoted as V2 in this description. In this configuration, from when the output voltage of the power storage unit 7 (the charge voltage) has reached a predetermined target voltage following the start of a charge operation at the predetermined charge start timing up to a predetermined discharge start timing (when a discharge operation of the discharge circuit 3B starts or up to when a discharge current starts to flow through the wiring section 81 via the wiring section 82), the output voltage of the power storage unit 7 (the charge voltage) is maintained at the predetermined target voltage (the output voltage when fully charged). In addition, this predetermined target voltage (the output voltage of the power storage unit 7 when it is fully charged) is greater than the voltage applied to the wiring section 81 (the first conducting path) based on the output voltage of the power source unit 91 when the power source unit 91 is fully charged.

Also in this example, if the voltage of the wiring section 83 (if the output voltage of the power source unit 91) is greater than the threshold value Vth when the ignition switch is in ON condition (when the IG relay 6 is in ON condition), the discharge circuit 3B is maintained in a discharge stop state and, conduction between the storage-unit-side conducting path 23 and the discharge-circuit-side conducting path 22 is blocked. Additionally, in this case, the flow of current from the wiring section 82 into the wiring section 81 is also blocked. In this configuration, the Zener diode 184C is provided between the power storage unit 7 and the wiring section 82 (the second conducting path) with the cathode of the Zener diode 184C electrically connected on the power storage unit 7 side and its anode electrically connected on the diode 80 side. Moreover, as the threshold value Vth is greater than the voltage V2 of the power storage unit 7 when it is fully charged minus the breakdown voltage VZ of the Zener diode 184C (V2-VZ), if at least the voltage of the wiring section 83 (the output voltage of the power source unit 91) is greater than the threshold value Vth, the potential difference between the storage-unit-side conducting path 23 and the wiring section 82 does not exceed the breakdown voltage VZ of the Zener diode 184C, so that no current flows through the Zener diode 184C or no current flows from the wiring section 82 to the wiring section 81.

On the other hand, if an abnormality occurs in the power supply from the power source unit 91 (e.g., occurrence of a ground fault or breakage in the vicinity of the power source unit 91) when the ignition switch is in ON condition (i.e., when the IG relay 6 is in ON condition) so as to stop the power supply from the power source unit 91 to the wiring section 81, the value of the voltage applied to the wiring section 83 (the WB voltage) changes from greater than or equal to the threshold value Vth to less than threshold value Vth if the power supply from the power source unit 91 to the wiring section 81 (the first conducting path) is stopped (specifically, if the voltage of the wiring 83 becomes less than threshold value Vth) as above, the control unit 5 switches the signal given to the discharge circuit 3B from a discharge stop signal to a discharge instruction signal to cause the discharge circuit 3B to perform a discharge operation to apply the predetermined target voltage (e.g., a voltage equivalent to the output voltage of the power source unit 91 when it is fully charged) to the discharge-circuit-side conducting path 22. The control of the control unit 5 and the operation of the discharge circuit 3B at this time are the same as Embodiment 1.

Also in this configuration, if the voltage of the wiring section 81 is greatly reduced compared to when in a normal condition due to the shutoff of the power supply from the power source unit 91, the voltage of the wiring section 82 connected to the anode side of the diode 80 is greater than the voltage of the wiring section 81 connected to the cathode side, so that a current immediately flows from the wiring section 82 to the wiring section 81. In this way, as a current can be immediately passed through the wiring section 81, the power supply to the load 93 is maintained until a discharge operation of the discharge circuit 3B is started.

The backup device 201 of this configuration can reduce the voltage applied to the wiring section 82 (the second conducting path) (the voltage applied via the Zener diode 184C based on the power supply from the power storage unit 7) due to the presence of the Zener diode 184C, making it possible to cope with cases in which the voltage of the power storage unit 7 is high when it is fully charged. If the relationship between the voltage of the wiring section 82 thus reduced and the voltage applied to the wiring section 81 (the first wiring section) when the power supply from the power source unit 91 is in a normal condition is such that the voltage of the wiring section 82 is lower than the voltage applied to the wiring section 81, flow from the wiring section 82 side to the wiring section 81 side can be prevented to prevent discharge of the power storage unit 7 in a normal condition. In this way, the configuration is such that discharge of the power storage unit 7 can be easily prevented even if the voltage of the power storage unit 7 is high when it is fully charged.

### Embodiment 3

The following describes a third embodiment.

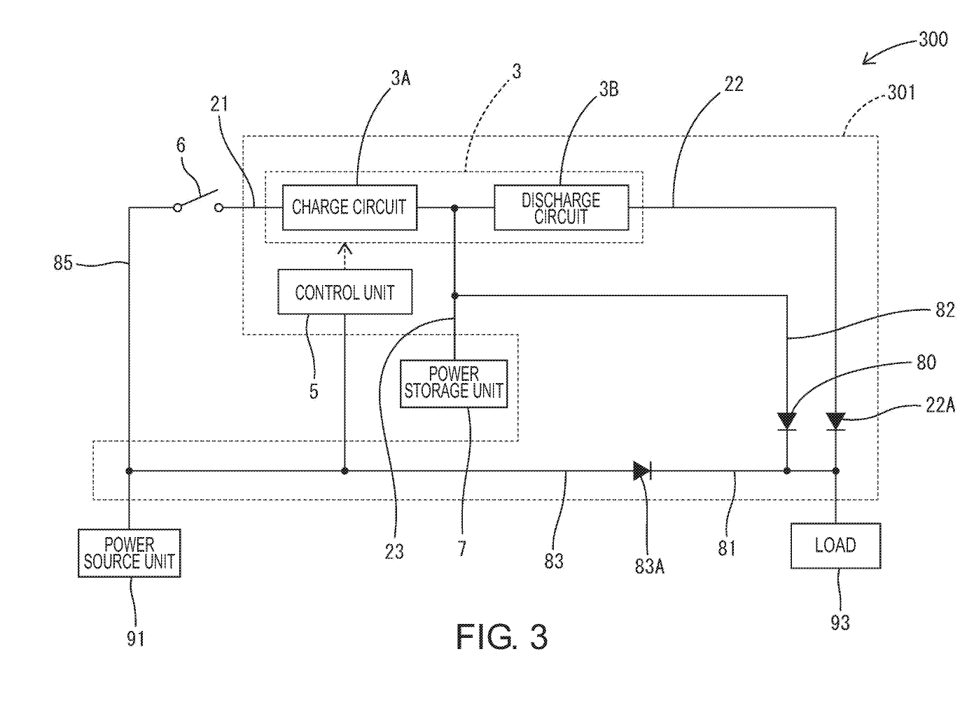

FIG. 3 shows a vehicle-mounted power source system 300 that employs a backup device 301 according to Embodiment 3. This vehicle-mounted power source system 300 and the backup device 301 differs from Embodiment 1 in that the auxiliary circuit section 84 is omitted in the route between the storage-unit-side conducting path 23 and the diode 80, maintaining only the wiring section 82, while the remaining circuit configuration is identical with Embodiment 1. Additionally, the various controls can be performed by the control unit 5 in the same manner as in Embodiment 1. In the vehicle-mounted power source system 300 of Embodiment 3, the same components as in Embodiment 1 will be denoted with the same reference symbols, and their detailed description will be omitted.

Also in this configuration, the wiring section 81 (the first conducting path) is provided between the power source unit 91 and the load 93 (the recipient of power) and configured to have a voltage based on the output voltage of the power source unit 91 applied thereto when the power supply from the power source unit 91 is in a normal condition. Additionally, the wiring section 82 is provided between the power source unit 7 and the wiring section 81 and configured to have a voltage applied thereto corresponding to the output voltage of the power source unit 7. Also, the diode 80 functions as an example of the element member, is provided between the wiring section 81 and the wiring section 82, restricts the flow of current from the wiring section 82 to the wiring section 81 when the voltage of the wiring section 82 is smaller than the voltage of the wiring section 81, and allows the flow of current from the wiring section 82 to the wiring section 81 when the voltage of the wiring section 82 is greater than the voltage of the wiring section 81.

The following describes the operation of the backup device 301.

Also in this configuration, when an IG ON operation (an ON operation to turn ON the ignition switch) is performed in the vehicle on which the vehicle-mounted power source system 300 is installed, the IG relay 6 is switched over to an ON state from an OFF state to establish conduction between the wiring section 85 and the charge-circuit-side conducting path 21. This causes the IG voltage to he applied to the backup device 301.

Then, the control unit 5 monitors the output voltage of the power source unit 91 at least from when the ignition switch is turned ON until it is turned OFF. In the backup device 301, a predetermined threshold value Vth is set as a value that is greater than the voltage V2 of the power storage unit 7 when it is fully charged and is smaller than the voltage of the power source unit 91 when it is fully charged, and the control unit 5 continuously monitors whether or not the voltage of the wiring section 83 (i.e., the output voltage of the power source unit 91) is greater than the threshold value Vth. Also in this example, the voltage of the wiring section 83 (the output voltage of the power source unit 91) is greater than the threshold value Vth when the power is appropriately supplied to the wiring section 81 from the power source unit 91 and when the flow of current is blocked from the wiring section 82 to the wiring section 81.

Also in this configuration, the charge operation of the charge circuit 3A is performed at a predetermined charge start timing (e.g., immediately after the ignition switch is turned ON) when the voltage of the wiring section 83 (i.e., the output voltage of the power source unit 91) is greater than the threshold value Vth, and a charge instruction signal is given to the charge circuit 3A from the control unit 5 until the output voltage of the power storage unit 7 (the charge voltage) reaches the target voltage. This “predetermined target voltage” represents an example of “the output voltage” of the power storage unit 7 “when it is fully charged” and is denoted as V2 in this description. In this configuration, from when the output voltage of the power storage unit 7 (the charge voltage) has reached a predetermined target voltage following the start of a charge operation at the predetermined charge start timing up to a predetermined discharge start timing (when a discharge operation of the discharge circuit 3B starts or up to when a discharge current starts to flow through the wiring section 81 via the wiring section 82), the output voltage of the power storage unit 7 (the charge voltage) is maintained at the predetermined target voltage (the output voltage when fully charged). In addition, this predetermined target voltage (the output voltage of the power storage unit 7 when it is fully charged) is smaller than the voltage applied to the wiring section 81 (the first conducting path) based on the output voltage of the power source unit 91 when the power source unit; 91 is fully charged. It should be noted that, in this configuration, the charge circuit 3A can be configured as a step-down DCDC converter than can at least perform a step-down operation, and if the target voltage (the output voltage at the time of full charge) is lower than the output voltage of the power source unit 91, the step-down operation of the charge circuit 3A can supply charge current to the power storage unit 7.

Also in this example, if the voltage of the wiring section 83 (the output voltage of the power source unit 91) is greater than the threshold value firth when the ignition switch is in ON condition (when the IG relay 6 is in ON condition), the discharge circuit 3B is maintained in a discharge stop state and, conduction between the storage-unit-side conducting path 23 and the discharge-circuit-side conducting path 22 is blocked. Additionally, in this case, as the voltage of the wiring section 81 applied based on the power source unit 91 is greater than the voltage of the wiring section 82, to which the output voltage of the power storage unit 7 is applied, the flow of current from the wiring section 82 to the wiring section 81 is also blocked.

On the other hand, if an abnormality occurs in the power supply from the power source unit 91 (e.g., occurrence of a ground fault or breakage in the vicinity of the power source unit 91) when the ignition switch is in ON condition when the IG relay 6 is in ON condition) so as to stop the power supply from the power source unit 91 to the wiring section 81, the value of the voltage applied to the wiring section 83 (the +B voltage) changes from greater than or equal to the threshold value Vth to less than threshold value Vth. If the power supply from the power source unit 91 to the wiring section 81 (the first conducting path) is stopped (specifically, if the voltage of the wiring 83 becomes less than threshold value Vth) as above, the control unit 5 switches the signal given to the discharge circuit 3B from a discharge stop signal to a discharge instruction signal to cause the discharge circuit 3B to perform a discharge operation to apply the predetermined target voltage (e.g., a voltage equivalent to the output voltage of the power source unit 91 when it is fully charged) to the discharge-circuit-side conducting path 22. The control of the control unit 5 and the operation of the discharge circuit 3B a this time are the same as Embodiment 1.

Also in this configuration, if the voltage of the wiring section 81 is greatly reduced compared to when in a normal condition due to the shutoff of the power supply from the power source unit 91, the voltage of the wiring section 82 connected to the anode side of the diode 80 is greater than the voltage of the wiring section 81 connected to the cathode side, so that a current immediately flows from the wiring section 82 to the wiring section 81. In this way, as a current can be immediately passed through the wiring section 81, the power supply to the load 93 is maintained until a discharge operation of the discharge circuit 3B is started.

In this way, in the backup device 301 of this configuration, as the voltage of the wiring section 82 disposed on the anode side of the diode 80 is smaller than the voltage of the wiring section 81 disposed on the cathode side when the power supply from the power source unit 91 is in a normal condition, the flow of current from the wiring section 82 to the wiring section 81 can be restricted. In addition, as the voltage of the wiring section 82 disposed on the anode side of the diode 80 is greater than the voltage of the wiring section 81 disposed on the cathode side when the power supply from the power source unit 91 is shut off, it is possible to immediately pass a current from the wiring section 82 to the wiring section 81. Moreover, such functions can be easily implemented with the diode 80 as the principal.

### Other Embodiments

The present invention is not limited to Embodiments 1-4 described in the above description and the drawings; for example, the following embodiments also fall under the technical scope of the present invention.

In the above-described Embodiments 1-3, although a lead battery is used as the power source unit 91, they are not limited to this configuration; in any of the examples in this specification, a different power source means (a different known storage means or generation means, etc.) may he used in place of or in combination with the power source unit 91. The number of power source means comprising the power source unit 91 is not limited to one; it may also be comprised of a plurality of power source means.

In the above-described Embodiments 1-3, although an electric double layer capacitor (EDLC) is used as the power storage unit 7, they are not limited to this configuration; in any of the examples in this specification, a different storage means, such as lithium ion battery, a lithium ion capacitor, or a nickel hydrogen rechargeable battery, may also be used. Moreover, the number of storage means comprising the power storage unit 7 is not limited to one; it may be comprised of a plurality of storage means.

In the above-described Embodiments 1-3, although a MOSFET is used as the switching element of the discharge circuit, they are not limited to this configuration; a different known semiconductor switching means, etc., may also be used. Specifically, any switching element will suffice as long as it is arranged in series with the Zener diode 184C disposed between the storage-unit-side conducting path 23 and the wiring section 82 so as to establish conduction between the storage-unit-side conducting path 23 and the wiring section 82 when the Zener diode 184C breaks down.

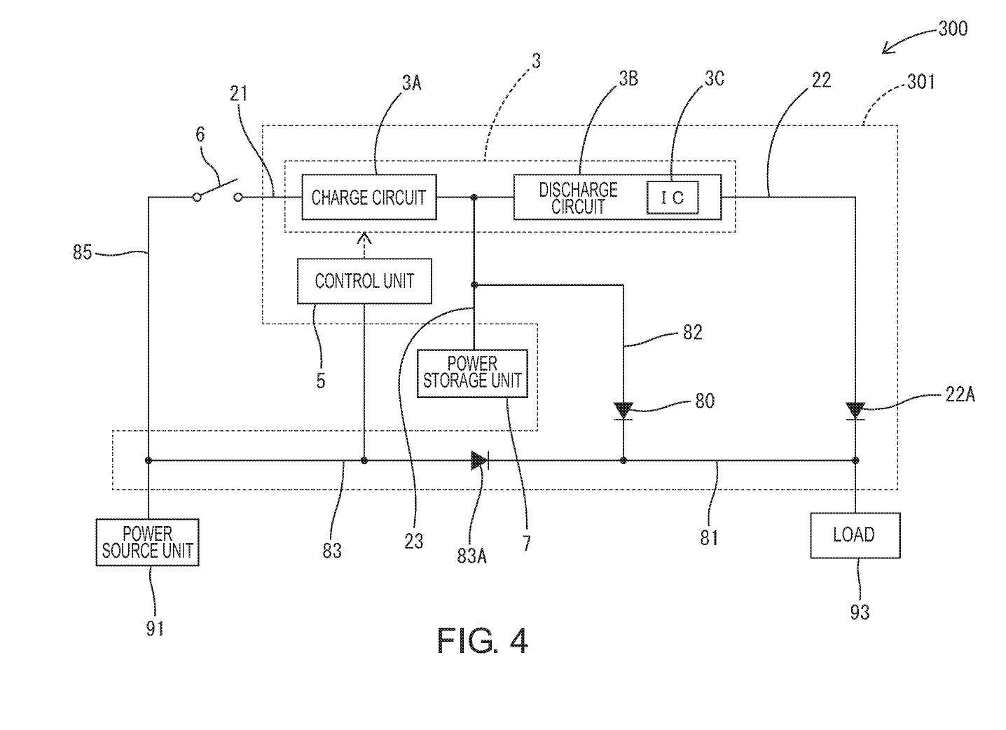

In the above-described Embodiments 1-3, although the control unit 5 is provided separately from the discharge circuit 3B, as shown in FIG. 4, an IC 3C may be provided in the discharge circuit 3B, and functions equivalent to those for controlling the discharge circuit 3B by the control unit 5 may be provided in the IC 3C. In this case, the IC 3C is configured as a control circuit, such as a microcomputer, such that it may be configured to be capable of ascertaining the output voltage of the power source unit 91 and the power storage unit 7. While FIG. 4 is a modified configuration of FIG. 3, the configurations of FIGS. 1 and 2 may also be similarly modified. Furthermore, in the example of FIG. 4, although the IC 3C is provided in the discharge circuit 313, an IC may be provided in the charge circuit 3A, functions equivalent to those for controlling the charge circuit 3A by the control unit 5 may be provided in the IC in the charge circuit.

### LIST OF REFERENCE NUMERALS

1, 201, 301 Backup device

3B Discharge circuit

7 Power storage unit

80 Diode (element member)

81 Wiring section (first conducting path)

82 Wiring section (second conducting path)

84C, 184C Zener diode

84 Resistor

84E Switching element

91 Power source unit

93 Load (recipient of power)

1. A backup device for a vehicle-mounted power source system that includes a main power source configured to supply power to a recipient of power and a power storage device that serves as a power supply source at least when the power supply from the main power source is shut off, the backup device comprising:
a first conducting path that is provided between the main power source and the recipient of power and to which a voltage based on an output voltage of the main power source is applied when the power supply from the main power source is in a normal condition;
a second conducting path provided between the power storage device and the first conducting path; and
an element member provided between the first conducting path and the second conducting path configured to: (i) restrict a flow of a current from the second conducting path to the first conducting path when the voltage of the second conducting path is smaller than the voltage of the first conducting path, and (ii) allow the flow of a current from the second conducting path to the first conducting path when the voltage of the second conducting path is greater than the voltage of the first conducting path.

2. The vehicle-mounted backup device according to claim 1, further comprising:
a discharge circuit arranged in parallel with the second conducting path between the power storage device and the first conducting path configured to perform a discharge operation to output a target voltage set for the first conducting path based on the output voltage from the power storage device and a stop operation to stop the discharge operation; and
controlling controller configured to control the discharge circuit;
wherein the controller causes the discharge circuit to perform the discharge operation at least when the power supply from the main power source to the first conducting path is stopped.

3. The vehicle-mounted backup device according to claim 2, wherein the output voltage of the power storage device when it is fully charged is smaller than the voltage applied to the first conducting path based on the output voltage of the main power source when the main power source is fully charged, and
wherein the element member is a diode that has an anode electrically connected to the power storage device via the second conducting path and a cathode electrically connected to the first conducting path.

4. The vehicle-mounted backup device according to claim 2, wherein the output voltage of the power storage device when it is fully charged is greater than the voltage applied to the first conducting path based on the output voltage of the main power source when the main power source is fully charged, and
wherein a Zener diode having a cathode electrically connected on the power storage device side and an anode electrically connected on the element member side is provided between the power storage device and the second conducting path and,
wherein the element member is a diode that has an anode electrically connected to the second conducting path and a cathode electrically connected to the first conducting path.

5. The vehicle-mounted backup device according to claim 2, wherein the output voltage of the power storage device when it is fully charged is greater than the voltage applied to the first conducting path based on the output voltage of the main power source device when the main power source device is fully charged, and
the vehicle-mounted backup device further comprising: a Zener diode provided between the power storage device and the second conducting path and having a cathode electrically connected on the power storage device side and an anode electrically connected on the element member side; and
a switching element provided between the power storage device and the second conducting path and being turned ON when the Zener diode breaks down to establish conduction between the power storage device and the second conducting path;
wherein the element member is a diode that has an anode electrically connected to the second conducting path and a cathode electrically connected to the first conducting path.
